(19) United States
(12) Patent Application Publication
(10) Pub. No.: US 2019/0040576 A1
(43) Pub. Date: Feb. 7, 2019

(54) Apparatus and Method for Processing a Rope Formed in a Pulper

(71) Applicant: Meri Environmental Solutions GMBH, München (DE)

(72) Inventors: Lucas MENKE, München (DE); Gisbert WÜNSCHE, Baienfurt (DE)

(73) Assignee: Meri Environmental Solutions GMBH, München (DE)

(21) Appl. No.: 16/073,904

(22) PCT Filed: Jan. 25, 2017
(86) PCT No.: PCT/EP2017/051505

§ 371 Date: Jul. 30, 2018

(30) Foreign Application Priority Data
Feb. 1, 2016 (DE) 10 2016 101 712.4

(51) Int. Cl. D21B 1/32; D21B 1/34; B02C 18/14; B02C 18/22

(52) U.S. Cl. CPC D21B 1/32; B02C 18/2283; B02C 18/142; D21B 1/345

(57) ABSTRACT

An apparatus for processing a rope formed in a pulper, comprising a conveying mechanism, in particular a winch, for pulling the rope, with the forward end first, out of the pulper, is characterized in that the conveying mechanism is positioned and designed in such a way that the rope can be fed, with the forward end first, directly to a shredder by the conveying mechanism.

The present invention relates to an apparatus and a method for processing a rope formed in a pulper with a conveying mechanism, in particular a winch, for pulling the rope with the forward end first out of the pulper.

Pulpers are used for pulping waste paper, dissolving cellulose pulps, dissolving cardboard, paperboard or the like. A pulper usually comprises a trough-like container that is filled with a solvent, such as water, for instance. Subsequently, waste paper is fed to said tank, for instance, and intensively mixed with the solvent in order to dissolve it. For mixing the two substances in most cases a mixing and comminuting rotor provided at the floor of the container of the pulper is applied.

In order to remove the interfering substances and impurities, a rope is usually hung into the pulper, such as a rope-like wire bundle. In particular rough, longish contaminations, such as films, packing tapes or textile remains spin into the rope that can be removed by pulling the rope out of the tank.

In WO 2012/062563 A1, a method for controlling a ragger that conveys a rope formed by impurities out of a pulper. Downstream the ragger a separator is provided which cuts the rope into single pieces.

It is moreover known from prior art to collect such pieces of the rope in tanks in order to transport them to an external treatment plant where they are processed further. The single rope pieces are thereby fed into a crushing device, for instance a shredder, in which they are hackled or shredded, respectively. The shredded material can then be separated into metal and plastic parts and other materials.

The processing of rope pieces is dangerous as they are wire nettings on which persons could easily injure themselves. In addition, the transport of such rope parts is complex and involves additional costs.

It is thus an objective of the present invention to provide a logistically particularly easy and cost-effective possibility for processing a rope formed in a pulper.

According to the invention, this objective is solved by an apparatus comprising the features of patent claim 1 or a method with the features of patent claim 15, respectively.

According to the invention, an apparatus for processing a rope formed in a pulper comprises a conveying mechanism, in particular a winch, for pulling the rope, with the forward end first, out of the pulper, wherein the conveying mechanism is positioned and designed in such a way that the rope can be fed, with the forward end first, directly to a shredder by the conveying mechanism.

In the apparatus according to the invention the rope is thus not only pulled out of the pulper by means of the conveying mechanism in order to be cut into small pieces that are subsequently processed. In fact, in the apparatus according to the invention the rope is pulled out of the pulper and is directly fed to a shredder with the forward end first. Any intermediate steps, as they are obligatory in prior art, i.e. in particular the separation of single rope pieces at the front end, the collection of rope pieces in tanks, the transport of the rope pieces to an external treatment plant and/or a handling of the rope pieces of any kind by an operator are thus avoided in the apparatus according to the invention. The processing of a rope formed in a pulper can thus take place in a significantly less complex, faster, more cost-efficient and safe way.

In the sense of the present invention a direct feeding of the rope to the shredder is particularly understood in such a manner that the rope is fed to the shredder directly from the conveying mechanism, i.e. that there is a spatially continuous conveying of the rope from the pulper to the shredder without cutting the rope into single pieces and without any other form of handling the rope.

The feeding of the front end of the rope into the shredder by means of the conveying mechanism furthermore has the advantage that the speed of feeding the rope to the shredder can be adjusted by means of the conveying mechanism. Depending on the current usage of the shredder it is thus possible to feed the front end of the rope faster or more slowly to the shredder. An overload or working under capacity of the shredder can thus be avoided.

Pursuant to a particularly preferred embodiment of the present invention, the shredder comprised in the mechanism is a two-shaft shredder. According to the invention it was realized that two-shaft shredders are particularly suitable for chopping or shredding ropes out of a pulper. As compared to a single-shaft shredder, they are usually less susceptible to errors and repairs. As compared to a single-shaft shredder it is moreover possible to reach a higher throughput and even coarser materials can be shredded.

The two-shaft shredder preferably comprises two rotatably drivable shafts, in particular moving in opposite directions that are at least substantially parallel to one another, with cutting elements for shredding the rope. The cutting elements can thereby be arranged in a row on each shaft. Between adjacent cutting elements of each shaft spacer disks may be provided so that between adjacent cutting elements of the same shaft a free space is formed. The cutting elements of a shaft are preferable displaced to the cutting elements of the respective other shaft in axial direction, so that the cutting elements of the one shaft and the spacer disks of the other shaft are opposed. A respective cutting element of the one shaft can thus engage with the free space between adjacent cutting elements of the other shaft or run through said free space, respectively, when the shafts are driven rotatably. When the shredder is operated, the cutting elements of the two shafts are thus passing each other in the area lying between the two shafts. In that, the cutting elements passing each other work together like a scissor in order to separate the materials conveyed through said area in small and smallest parts.

By contrast, in a single-shaft shredder the fed material is conveyed between a shaft and a fixed stator. The cutting into small parts typically takes place in that fed material is sticking to the stator and the rotating shaft pulls apart the material, thus tearing it into small pieces. In a single-shaft shredder, the cutting elements are usually integral with the shaft.

In the two-shaft shredder, the cutting elements may be demountable from the shaft. The cutting elements can thus be removed from the shaft and maintained, in particular reground. The operating costs can be reduced in this manner, in particular when compared to a single-shaft shredder, in which the cutting elements are integrated in the shaft, so that the entire shaft has to be exchanged as soon as the cutting elements are worn.

The cutting elements can be exchangeable. By exchanging the cutting elements, it is possible to realize different grades of crushing. It is moreover not necessary to exchange the entire shaft in case of completely worn cutting elements. In this manner, the operating costs can be kept at a low level.

However, the shafts can be exchangeable as well. The exchange of a complete shaft can be carried out relatively quickly. With that, service lives can be kept short.

The conveying mechanism can particularly be positioned and designed in such a manner that the front rope end can be fed to an area of the shredder that is positioned between the two shafts. The front end of the rope can be pulled in the so-called shredder region between the two shafts by means of the shafts rotating in the opposite direction and separated by the cutting elements.

The shredder is preferable positioned in such a manner that the shafts are extending at least substantially parallel to a direction, along which the front end of the rope is fed to the shredder. The longitudinal extension of the conveyed front end of the rope is thus parallel to the shafts. The front end of the rope can thus be taken up by the shafts rotating in opposite directions and pulled in the shredder region for shredding in a particularly good way.

For each shaft a separate drive, in particular an electric or hydraulic drive, can be provided, whereby the drives are preferable operable independently from one another. The shafts can thus be individually and independently operated. The shafts can particularly be operated with different rotation speeds. In addition, the rotation direction of a shaft can be changed at least temporarily, while the rotation direction of the other shaft is maintained.

By using electric or hydraulic drives, it is possible to provide high-performance and robust drives for the shafts. A hydraulic drive can be designed in a compact manner and is suitable to provide a proportionately high torque which can additionally be controlled or steered easily. An electric engine is rather inexpensive and more silent than a hydraulic drive.

According to another preferred design of the invention, the apparatus according to the invention comprises a control for the conveying mechanism, whereby the control is designed to adjust the conveying speed and/or the conveying direction of the rope based on at least one operating parameter of the shredder. An overload or work below capacity of the shredder can be avoided by the corresponding adjustment of the conveying speed and/or the conveying directions of the rope.

It can particularly be provided that the control adjusts the conveying speed of the rope primarily based on at least one parameter relating to the pulper. The rope, for instance, can be continuously pulled out of the pulper, whereby the conveying speed depends on the quantity of material that accumulated at the rope. Secondarily, the conveying speed and/or possibly even the conveying direction of the rope can be adjusted based on the operating parameters of the shredder. This can be realized, for instance, by determining an offset value based on the operating parameter of the shredder, by which—depending on the preceding sign of the offset value—the current conveying speed is increased or reduced, respectively.

An adjustment of the conveying direction particularly means that the front end of the rope is usually conveyed in the direction of the shredder. For instance, in case of a high overload of the shredder, however, it may exceptionally also be provided to pull the front end of the rope away from the shredder for at least a short time in order to disburden the shredder.

The operating parameter is in particular the hydraulic pressure of the hydraulic drive of the shredder and/or the torque at a shaft of the shredder and/or an electric parameter, in particular current or voltage, of the electric drive of the parameter. By measuring one of the aforementioned operating parameters the current workload of the shredder can be determined in a simple way.

The apparatus may comprise a measuring unit for measuring the hydraulic pressure and/or for measuring the torque and/or for measuring the electric parameter. The measured value determined by the measuring unit may be provided for the control of the conveying mechanism.

The conveying mechanism preferably comprise a winch with a drivable roll and a counter roller and is designed in such a manner that the rope is conveyed between the roll and the counter roller. By means of said winch, a simple, cost-effective and robust conveying mechanism for the rope is provided.

The apparatus according to the invention preferably comprises a pulper, whereby the conveying mechanism is arranged above the pulper and between the pulper and the shredder, in particular without providing a cutting device between the conveying mechanism and the shredder, especially scissors or the like, for separating the forward end of the rope from the remaining rope.

The pulper may in particular be provided as a so-called LC pulper or a so-called HC pulper. HC pulper are usually operated at a concentration of approximately 10%+2% of dissolved substances in the used solvent, such as water. They are used, for instance, for dissolving brown waste paper, as it is used for producing carton lines. LC pulper, on the other hand, are operated at low concentrations of substances dissolved in the solvent.

The apparatus according to the invention may comprise a guidance device, in particular a slide, between the conveying mechanism and the shredder for conveying the forward end of the rope. The forward end of the rope may thus be forcibly actuated in order to feed the forward end of the rope to the shredder in a desired direction. By means of the guidance device it may, for instance, be ensured that the forward end of the rope is fed longitudinally to a direction that is extending substantially parallel to the shafts of a two-shaft shredder.

The rotation speed and/or the direction of rotation of at least one shaft of the shredder can be adjusted depending on the torque at the shaft and/or the hydraulic pressure of the drive of the shaft. With that, an overload or work below capacity of the shredder can be avoided.

Preferably a measuring unit for measuring the torque and/or for measuring the hydraulic pressure is provided.

Along with the shredder another shredder, in particular a two-shaft shredder, can be arranged downstream. By way of two shredders arranged one after the other a relatively high crushing ratio of the shredded material can be achieved.

The invention furthermore relates to a method for processing a rope formed in a pulper, in particular by means of the apparatus according to the invention, wherein the rope, with the forward end first, is pulled out of the pulper by means of a conveying mechanism for the rope, in particular a winch, and whereby the rope by means of the conveying mechanism is fed, with the forward end first, directly to a shredder.

The rope is preferably fed directly to a two-shaft shredder with its forward end first by means of the conveying mechanism.

Preferably at least one operating parameter of the shredder is measured and the conveying speed and/or the conveying direction of the rope are set based on the at least one operating parameter.

Hereafter, the present invention is exemplified with reference to the drafts. The figures show the following, each schematically:

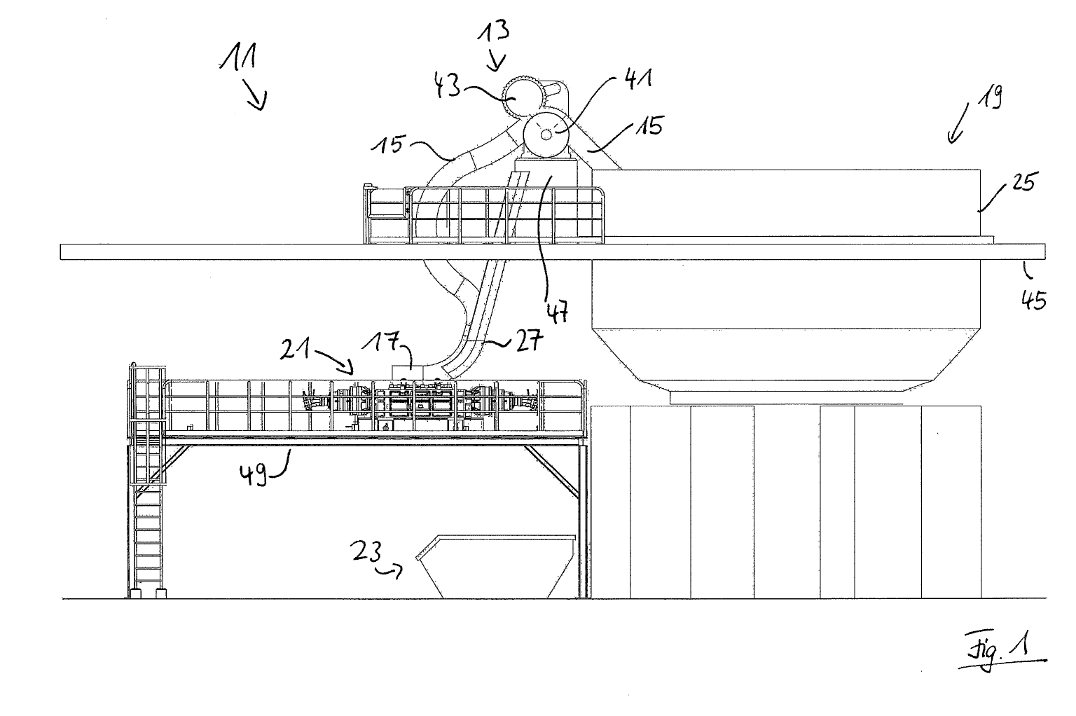

FIG. 1 a side view of an apparatus according to the invention,

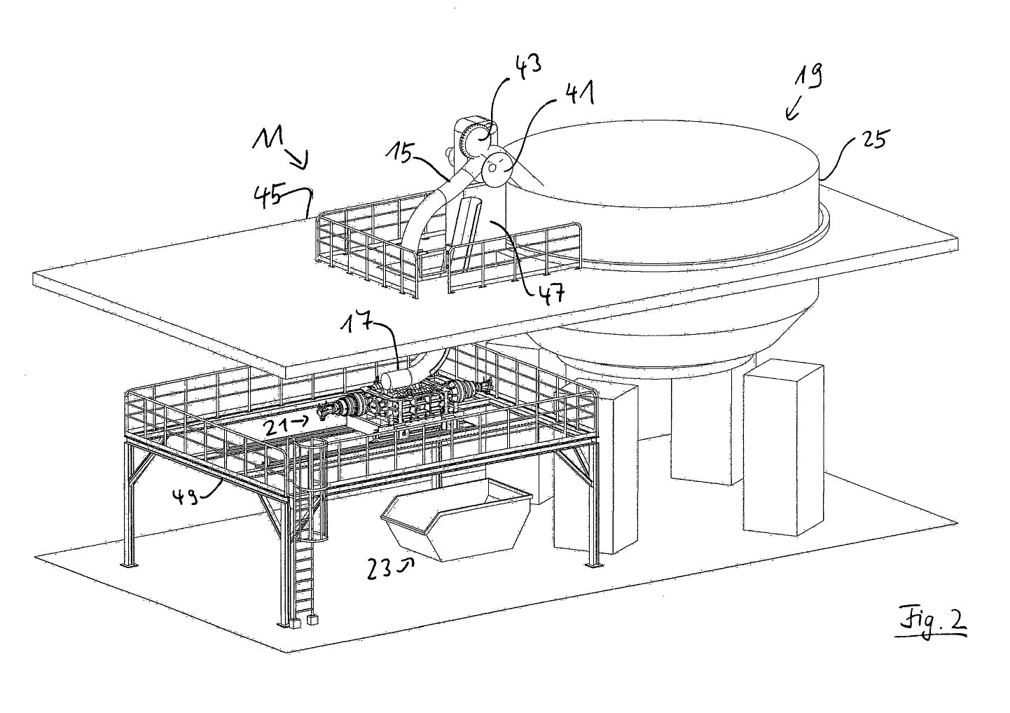

FIG. 2 a perspective view of the apparatus of FIG. 1,

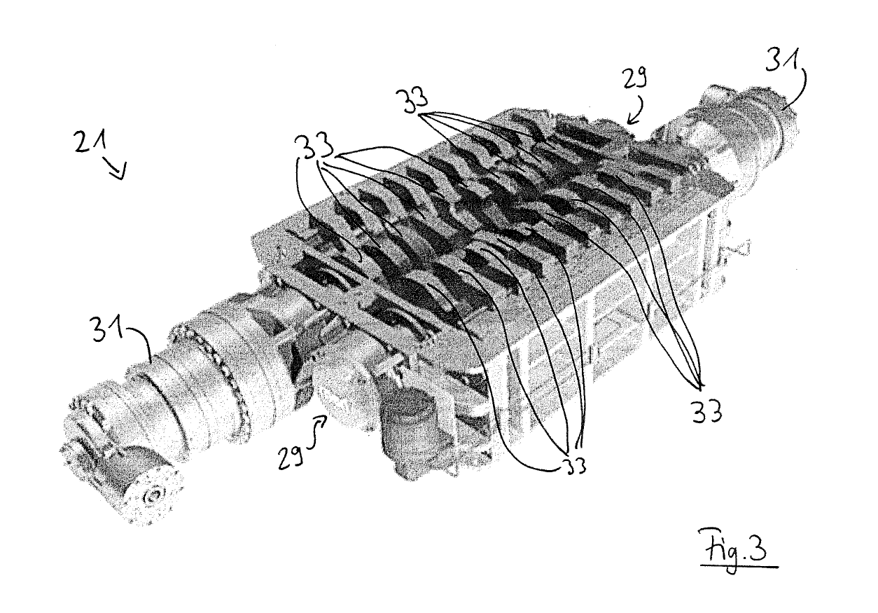

FIG. 3 a perspective partial view of a two-shaft shredder of the apparatus according to FIG. 1,

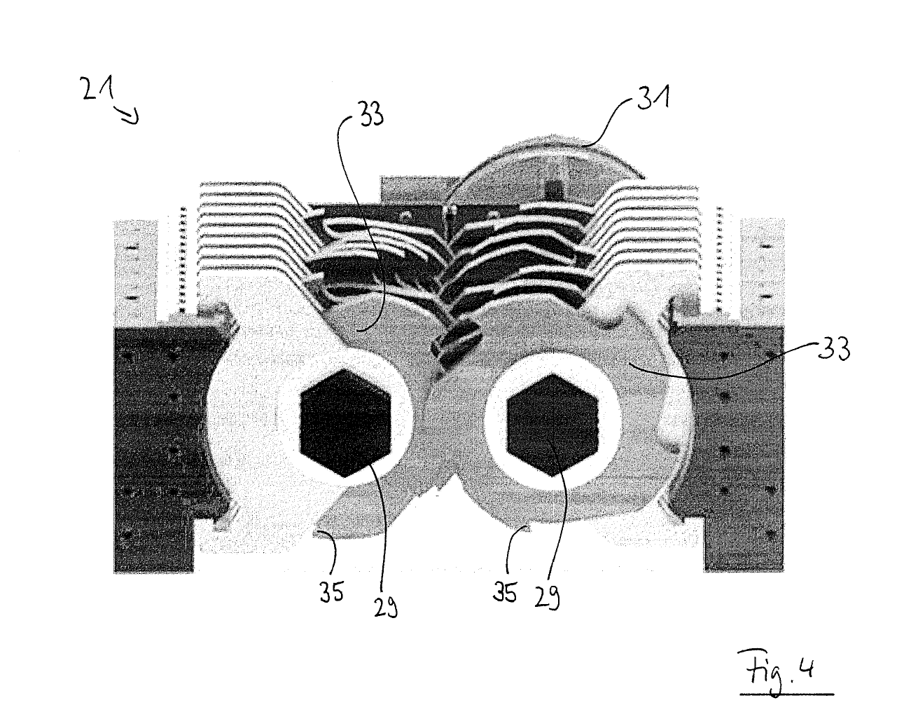

FIG. 4 another partial illustration of the shredder of FIG. 3,

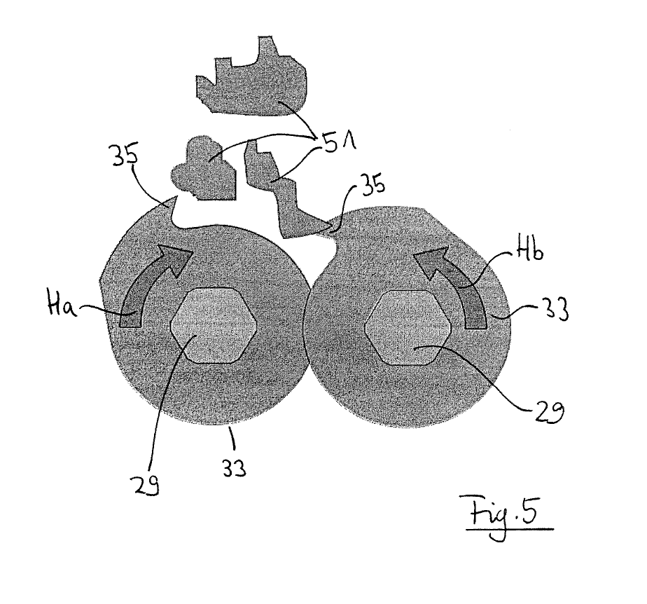

FIG. 5 a schematic illustration for explaining the functioning principle of the shredder shown in FIG. 3, and

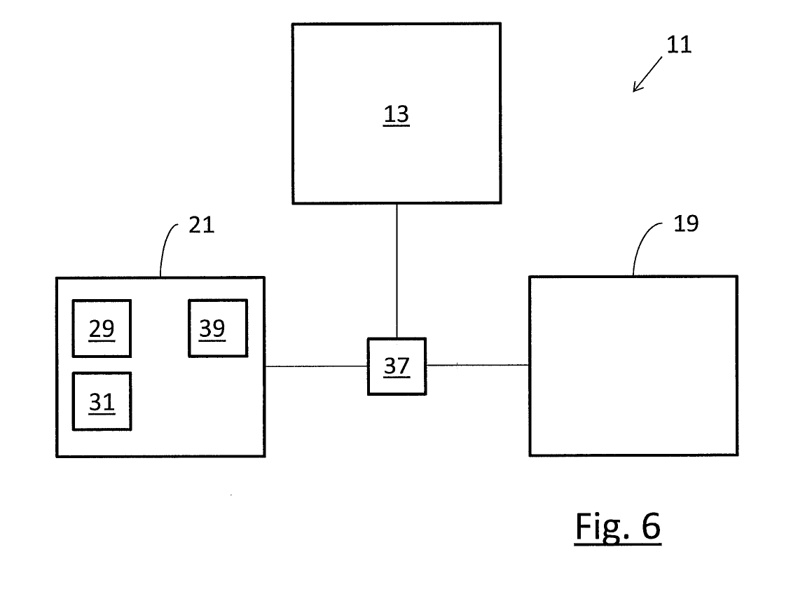

FIG. 6 a block diagram of the apparatus shown in FIG. 1.

The apparatus 11 shown in FIGS. 1 and 2 comprises a conveying mechanism 13 for pulling a rope 15 with the forward end 17 first, out of a pulper 19. The conveying mechanism 13 is thereby arranged and designed in such a way that the rope 15 can be fed, with the forward end 17 first, directly to a shredder 212 by the conveying mechanism 13.

The pulper 19 comprises a trough-like tank 25 open to the top that is filled with water and in which the material to be dissolved, such as waste paper, cellulose, cardboard or paperboard is imported and intensively meshed with the water in order to dissolve it. In this respect, it is possible to use a mixing and comminuting rotor (not shown) arranged at the bottom of the tank.

As shown in FIGS. 1 and 2, the rope 15 is hanging into the tank. The rope 15 is a rope-like wire bundle, into which primarily coarse, insoluble impurities, such as transparent films, packing tapes or textile scraps are spun.

The conveying mechanism 13 is provided as a winch and comprises a driven roll 41 and a counter roller 43, wherein the rope is conveyed between the roll 41 and the counter roller 43.

As is also apparent from FIGS. 1 and 2, the conveying mechanism 13 is arranged above the pulper 19 and—at least from a functional point of view—between the pulper 19 and the shredder 21, so that the forward end of the rope 17 can not only be pulled out of the pulper 19 by the conveying mechanism 13, but also be fed to the shredder 21.

In the apparatus 11 shown in FIGS. 1 and 2 an upper platform is provided, through which the tank 25 protrudes. The conveying mechanism 13 is arranged on a socket 47, which is standing on the upper platform 45. The conveying mechanism 13 is thereby arranged sideways next to and above the opening of the tank in order to pull the rope 15 out of the tank 25.

The shredder 21 is arranged on a rack 49 beneath the platform 45. The shredded material falling out of the shredder 21 at the bottom falls into a container 23 provided beneath the shredder 21, or beneath the rack 49, respectively.

The conveying speed with which the conveying mechanism 13 pulls out the rope 15 of the tank can be set in such a manner that a reasonable spinning of impurities on the rope is possible without risking that the rope 15 is too big. The conveying speed can thus primarily be associated with the spinning of material on the rope 15 in the pulper 19.

A guidance device 27 is arranged between the conveying mechanism 13 and the shredder 21 in form of a slide, which supports the conveying of the forward end of the rope 17 to the shredder, namely in such a manner that the forward end of the rope 17 is fed at least substantially parallel to two parallelly extending shafts 29 of the shredder 21 (cf. FIG. 3).

The shredder 21 is thus provided as two-shaft shredder. Each shaft 29 comprises its own hydraulic drive 31 which can drive the respective shaft 29 rotatably. As an alternative, the drive 31 can also be provided as electric drive.

Cutting elements 33 are arranged on each shaft 29 of the shredder 21, wherein between the adjacent cutting elements 33 of one shaft at least one spacer disk 29 is arranged. Adjacent cutting elements 33 of one shaft are thus spaced apart relative to one another. The cutting elements 33 of the two shafts 29 are offset to one another in an axial direction, so that each cutting element 33 of one shaft is opposed to the respective spacer disk of the other shaft. The cutting elements 33 of the one shaft 29 thus engage with the free spaces formed by means of the spacer disks of the other shaft 29. As is apparent from the cross-sectional views in FIGS. 4 and 5, the cross-section of a cutting element 33 of the one shaft 29 thus overlaps with the cross-section of the adjacent cutting element 33 of the other shaft 29 in the region between the two shafts. In case of counter-rotating shafts 29, the cutting elements 33 of the two shafts are thus passing each other, thereby separating or shredding the material 51 (cf. FIG. 5), which is conveyed between the two shafts 29.

Each cutting element 33 comprises at its outer circumference at least one hooked projection 35, the tip of which is pointing in the direction of the respective main direction of rotation of the respective shaft 29. As shown in FIG. 5 by the arrows, the main direction of ration Ha for the left shaft 29 moves clockwise, while the main direction of rotation Hb for the right shaft 29 moves counter-clockwise.

When the shafts 29 run counter-rotate in their respective main directions of rotation Ha, Hb, the fed material 51, in particular by means of the at least one protrusion 35, can be taken up by the shafts 29 and pulled in the shredding area between the two shafts 29 and be shredded there.

Due to the separate drives 31 for the shafts 29, the direction of rotation Ha, Hb of at least one shaft 29 can be shortly reversed. This may in particular take place if for a short time a lot of material 51 is added. By reversing the direction of rotation, the material 51 can be conveyed to the top from the shredding area between the two shafts 29, in order to disburden the shredder 21.

By means of a control 37 (cf. FIG. 6) for the conveying mechanism 13, the conveying speed of the rope 15 can be adjusted also based on one operating parameter of the shredder 21. In this way, an overload or work below capacity of the shredder 21 can be avoided.

The operating parameter might be the hydraulic pressure of one of the hydraulic drives 31 for the shafts 29, for instance, or the torque at one of the shafts 29. For measuring the torque or the hydraulic pressure, a measuring unit 39 can be arranged in the shredder 21, which delivers the respective measured value to the control 37.

If, for instance, the hydraulic pressure or the torque exceeds a specific, preset threshold value, this might be seen as an indication that the shredder 21 is strongly loaded. Thereupon, the control 37 may reduce the conveying speed of the rope 15 by controlling the conveying mechanism 13 accordingly. In exceptional cases the conveying direction of the rope 15 can be reversed as well in order to pull the forward end 17 of the rope 15 out of the shredder 21. If, on the contrary, the measured hydraulic pressure or the measured torque falls low of another preset, lower threshold value, this can be seen as an indication that the shredder 21 works below capacity. The conveying speed of the rope 15 can then be increased by activating the conveying mechanism 13 accordingly.

Another second shredder can be arranged downstream the shredder 21 (not shown) in order to comminute the parts comminuted by means of the shredder 21 even further.

### LIST OF REFERENCE NUMBERS

11 apparatus
13 conveying mechanism
15 rope
17 forward end of the rope
19 pulper
21 shredder
23 container
25 tank
27 guiding device
29 shaft
31 drive
33 cutting element
35 projection
37 control
39 measuring unit
41 roll
43 counter roller
45 platform
47 socket
49 rack
51 material
Ha main direction of rotation
Hb main direction of rotation

1-17. (canceled)

18. An apparatus for processing a rope (15) formed in a pulper (19) comprising a conveying mechanism (13) for pulling the rope (15) with the forward end (17) first out of the pulper (19), wherein the conveying mechanism (13) is arranged and designed in such a manner that the rope (15) can be fed, with the forward end (17) first, directly to a shredder (21) by the conveying mechanism (13).

19. The apparatus according to claim 18, wherein the shredder (21) is a two-shaft shredder.

20. The apparatus according to claim 18, wherein the two-shaft shredder (21) comprises two rotatably driven shafts (29) extending at least substantially parallelly, with cutting elements (33) for shredding the rope (15).

21. The apparatus according to claim 20, wherein the cutting elements (33) are dismountable from the shafts (29) and/or exchangeable, and/or that the shafts (29) of the shredder (21) are exchangeable.

22. The apparatus according to claim 19, wherein the forward end of the rope (17) can be fed to a region of the shredder (21) which lies between the two shafts (29), and/or in that the shredder (21) is arranged in such a manner that the shafts (29) are extending at least substantially parallel to a direction alongside which the forward end of the rope (17) is fed to the shredder (21).

23. The apparatus according to claim 19, wherein for each shaft (29) a separate drive (31) is provided.

24. The apparatus according to claim 18, wherein said apparatus comprises a control (37) for the conveying mechanism (13), wherein the control (37) is arranged in a manner to adjust the conveying speed and/or the conveying direction of the rope (15) based on at least one operating parameter of the shredder (21).

25. The apparatus according to claim 24, wherein the operating parameter is the hydraulic pressure of the hydraulic drive (31) of the shredder (21) and/or the torque on one shaft (29) of the shredder (31sic!) and/or an electric parameter of the electric drive (31) of the shredder (21).

26. The apparatus according to claim 25, wherein said apparatus comprises a measuring unit (39) for measuring the hydraulic pressure and/or for measuring the torque and/or for measuring the electric parameter.

27. The apparatus according to claim 18, wherein the conveying mechanism (13) comprises a winch with a drivable roll and a counter roller and is designed in such a manner that the rope (15) is conveyed between the roll and the counter roller.

28. The apparatus according to claim 18, wherein said apparatus moreover comprises a pulper (19), wherein the conveying mechanism (13) is arranged above the pulper (19) and between the pulper (19) and the shredder (21).

29. The apparatus according to claim 18, wherein said apparatus comprises a guidance device (27) between the conveying mechanism (13) and the shredder (21) for guiding the forward end of the rope (17).

30. The apparatus according to claim 18, wherein the rotation speed and/or the direction of rotation of at least one shaft (29) of the shredder (21) is set based on the torque on the shaft (29) and/or the hydraulic pressure of the drive (31) of the shaft (29).

31. The apparatus according to claim 18, wherein another shredder is arranged downstream the shredder (21).

32. A method for processing a rope (15) formed in a pulper (19), wherein the rope (15) with its forward end (17) first is pulled out of the pulper (19) by means of a conveying mechanism (13) for the rope (15), and wherein the rope (15) is fed, with the forward end (17) first, directly to a shredder (21) by the conveying mechanism (13).

33. The method according to claim 32, wherein the rope (15), with its forward end (17) first, is fed directly to a two-shaft shredder (21) by the conveying mechanism (13).

34. The method according to claim 32, wherein at least one operating parameter of the shredder (21) is measured and the conveying speed and/or the conveying direction of the rope (15) is set based on the at least one operating parameter.
